(19) United States
(12) Patent Application Publication
(10) Pub. No.: US 2011/0237218 A1
(43) Pub. Date: Sep. 29, 2011

(54) MOBILE TERMINALS, AND EARTHQUAKE AND TSUNAMI WARNING SYSTEM

(75) Inventors: Takahisa Aoyama, Kanagawa (JP); Jun Hirano, Kanagawa (JP)

(73) Assignee: PANASONIC CORPORATION, Osaka (JP)

(21) Appl. No.: 13/132,443

(22) PCT Filed: Dec. 14, 2009
(86) PCT No.: PCT/JP2009/006839

§ 371 Date: Jun. 2, 2011

(30) Foreign Application Priority Data
Dec. 17, 2008 (JP) 2008-320859

(51) Int. Cl. H04W 4/22

(52) U.S. Cl. 455/404.1

(57) ABSTRACT

An ETWS according the invention comprises a macro base station, an HeNB, and a mobile terminal (1). The mobile terminal (1) comprises: a receiving section (11) for receiving paging and system information; a mobile control section (15) for controlling the receiving section (11) to receive paging from the macro base station even when the mobile terminal is in connection with the HeNB and in an idle state; a system information processing section (13) for processing system information transmitted from the macro base station to receive ETWS information when the received paging indicates that the ETWS information is present; and an ETWS information transmitting section (16) for transmitting the ETWS information to the HeNB. The HeNB transmits the ETWS information transmitted from the mobile terminal (1) to other mobile terminals (1). An ETWS and a mobile terminal that reduce a load of transmitting ETWS information to a number of home base stations are thereby provided.

### RELATED APPLICATIONS

The present application claims benefit of Japanese Patent Application No. 2008-320859, filed Dec. 17, 2008, the contents of which are hereby incorporated by reference.

### TECHNICAL FIELD

The present invention relates to the Earthquake and Tsunami Warning System (also referred to as “ETWS” hereinafter) for giving warning to a mobile terminal in case of disaster.

### BACKGROUND ART

In E-UTRA/E-UTRAN, which is being standardized, a new technology called ETWS for giving warning to a mobile terminal in case of disaster will be introduced. Messages that will be transmitted in the ETWS will now be described.

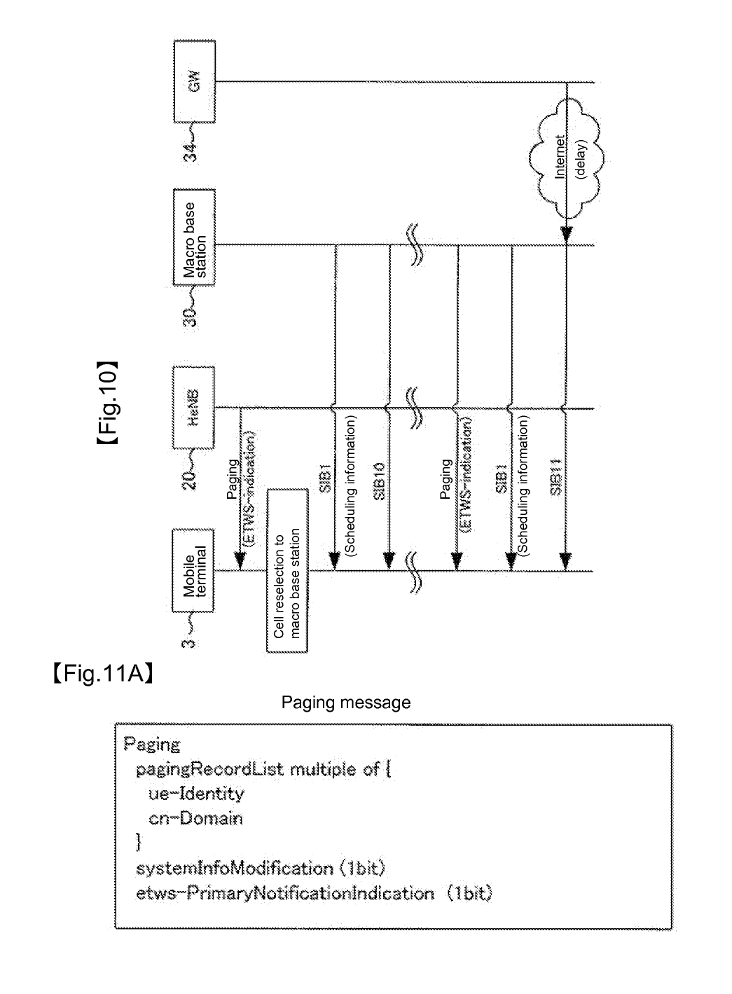

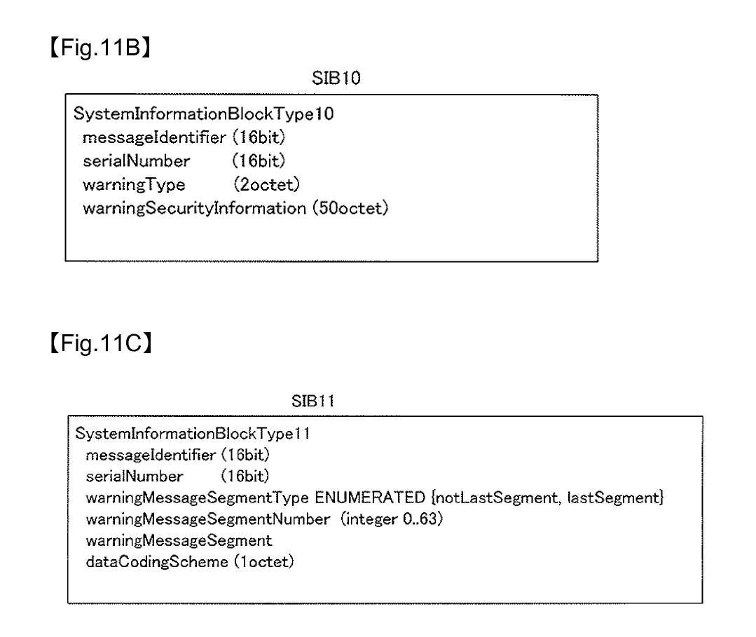

FIGS. 11A to 11C show message configurations used in the ETWS. FIG. 11A shows a paging message. The paging message includes a flag called “etws-Primary notification Indication” (hereinafter referred to as “ETWS start flag”) indicative of whether or not an ETWS message is being transmitted. The ETWS start flag notifies a mobile terminal of the presence or absence of the ETWS message. The ETWS start flag in a paging message is turned on to notify the mobile terminal of transmission of the ETWS message being started.

FIG. 11B shows a configuration of SIB 10. SIB 10 notifies an initial warning report called “Primary Notification”. The Primary Notification includes “warning Type” indicative of a cause of ETWS, a message identifier “message Identifier”, a message number “serial Number”, and “warning Security Information” indicative of confidentiality. Causes of ETWS include, for example, earthquake, tsunami, test, and other information. The message Identifier is information used to determine whether the Primary Notification is the same as one that has been received previously. There is a requirement that the Primary Notification should be delivered to mobile terminals within 4 seconds after an ETWS presenting device detects earthquake information. The Primary Notification has only several bits for warningType; however, it reaches 30 to 50 bites in length with information in warningSecuritylnformation included.

FIG. 11C shows a configuration of SIB 11. SIB 11 carries required secondarily information called Secondary Notification including detailed information on the disaster and places of refuge. The disaster and places of refuge are contained in “warning Message Segment” for transmission. Similar to SIB 10, SIB 11 includes “message Identifier” and “serial Number”. The Secondary Notification may be divided into a plurality of segments for transmission because of the large size of the Secondary Notification. SIB 11 includes “warning Messag eSegment Type” indicative of whether the segment is the last of the message, “warning Message Segmen tNumber” indicative of the order of the segments, and “data Coding Scheme” indicative of the coding scheme. A mobile terminal can check “warning Message Segment Type” to recognize whether all segments are ready. “warning Message Segment Number” is responsible for supporting the order of segments for synthesis as well as for ensuring that there is no missing message. Any temporal requirement is not specified to the Secondary Notification. In the Secondary Notification, an amount of information on the order of 1500 bites may be transmitted. ETWS information will be brought to a mobile terminal by the three types of messages as described above.

For simplicity, the terms SIB 1, SIB 10, and SIB 11 are used herein. When SIB 1, SIB 10, and SIB 11 are transmitted as RRC messages, SIB 1 is transmitted in a SystemInformationBlockType1 message, and SIB 10 and SIB11 are transmitted in a SystemInformation message.

A mobile terminal receives SIB 1 (System Information Block Type1 message) transmitted from a base station if the ETWS start flag is on in a received paging. The mobile terminal acquires transmission scheduling information for an ETWS message from the SIB 1. The mobile terminal receives SIB 10 notifying Primary Notification and SIB 11 notifying Secondary Notification according to the scheduling information.

Meanwhile, E-UTRA/E-UTRAN will introduce the Home evolved Node B (HeNB) technology. An HeNB is a micro base station intended for home, offices, campuses, coffee shops, shopping malls and the like. Unlike a base station that provides common cellular services (hereinafter referred to as “macro base station”), the HeNB is capable of accommodating only specific users. Possible specific users include family members if the HeNB is deployed at home, employees if the HeNB is deployed at an office, students if the HeNB is deployed at a campus, and customers if the HeNB is deployed at a coffee shop or a shopping mall. Since the HeNB is intended to accommodate only such specific users, 3GPP defines a cell provided by the HeNB as a Closed Subscriber Group, or CSG. 3GPP specifications are standards for standardizing cellular phone systems.

When a mobile terminal enters a range in which the mobile terminal can communicate with an HeNB, it is desirable for the mobile terminal to switch to the HeNB from the macro base station. This is because, rather than communicating with a remotely located macro base station, communicating with a nearby HeNB can reduce transmitted power and suppress interference so as to achieve a better wireless environment.

### CITATION LIST

### Non Patent Literature

Non Patent Literature 1: 3GPP T536.304

Non Patent Literature 2: 3GPP T536.300

Non Patent Literature 3: 3GPP T536.331

### SUMMARY OF INVENTION

### Technical Problem

When an ETWS message is to be transmitted to a mobile terminal connected to a HeNB, problems are anticipated as described below.

Each HeNB is in connection with an operator's HeNB gateway independently. Transmitting an ETWS message to all the independent connections is therefore costly.

Since the HeNB is connected through an Internet line at each home, it is more likely to experience a delay than a cellular network. It is required to deliver the Primary Notification described above to a mobile terminal within a certain period (for example, within 4 seconds). The Internet lines provide services on a best effort basis, and the requirement is not necessarily satisfied. The problem may be exacerbated particularly when the amount of information increases.

Further, the Internet line is considered to be less durable than a cellular network, and is not suitable for an infrastructure in case of disaster.

In view of such circumstances, it is an object of the invention to provide an Earthquake and Tsunami Warning System and a mobile terminal that reduce a load of transmitting ETWS information to a number of home base stations each in connection with a HeNB gateway independently.

### SOLUTION TO PROBLEM

An Earthquake and Tsunami Warning System according to an embodiment comprises: a macro base station; a home base station; and a mobile terminal, the mobile terminal comprises: a paging receiving section for receiving paging transmitted from the macro base station or the home base station; a control section for controlling the paging receiving section to receive paging from the macro base station even when the mobile terminal is in connection with the home base station and in an idle state; an ETWS receiving section for receiving ETWS information transmitted from the macro base station when the received paging indicates that the ETWS information is present; an ETWS transmitting section for transmitting the ETWS information to the home base station, and the home base station comprises: an ETWS receiving section for receiving the ETWS information transmitted from the mobile terminal; and an ETWS transmitting section for, when the receiving section receives the ETWS information, transmitting system information that includes the ETWS information received from the mobile terminal.

### ADVANTAGEOUS EFFECTS OF INVENTION

According to the present invention, a mobile terminal can acquire ETWS information through a macro base station even when the mobile terminal is in connection with a home base station. A mobile terminal that has received ETWS information transfers the ETWS information to the home base station. The home base station can therefore acquire the ETWS information through the mobile terminal and then notify other mobile terminals of the acquired ETWS information. In this way, a load of transmitting ETWS information to a number of home base stations each in connection with a HeNB gateway independently can be reduced.

As described below, there are other embodiments of the invention. Therefore, the disclosure of the invention is intended to provide a part of the invention and is not intended to limit the scope of the invention as described and claimed herein.

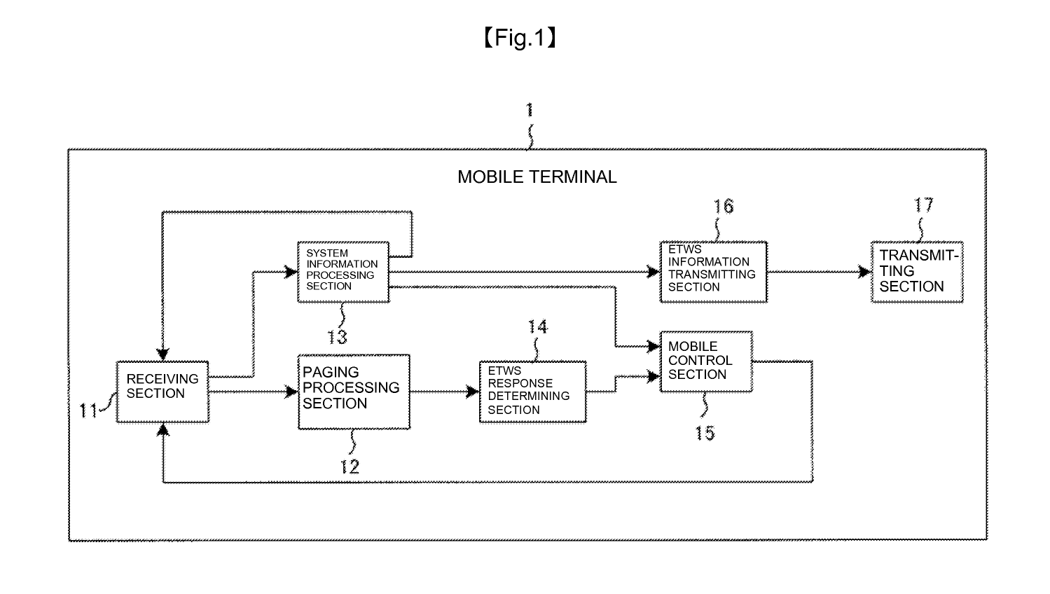

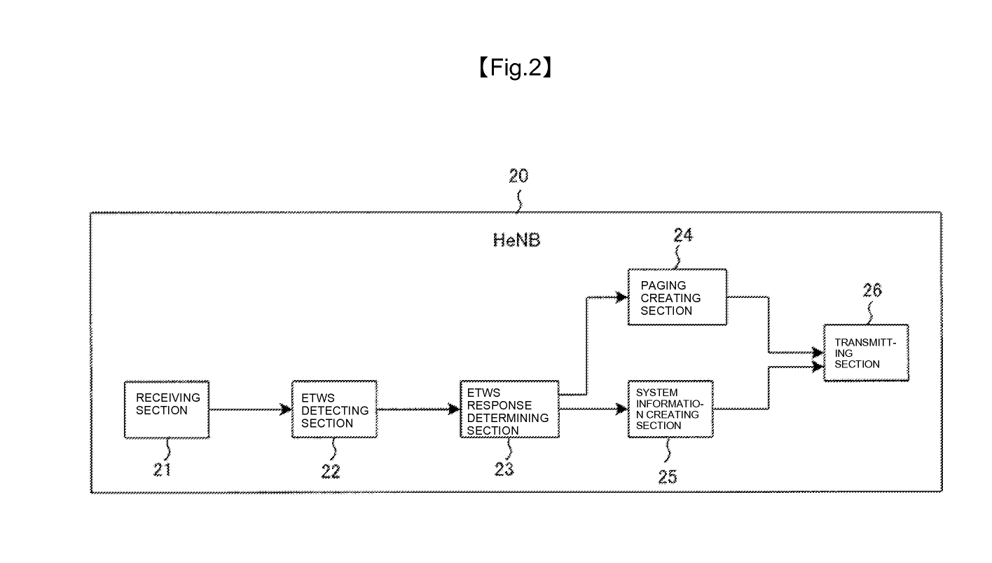

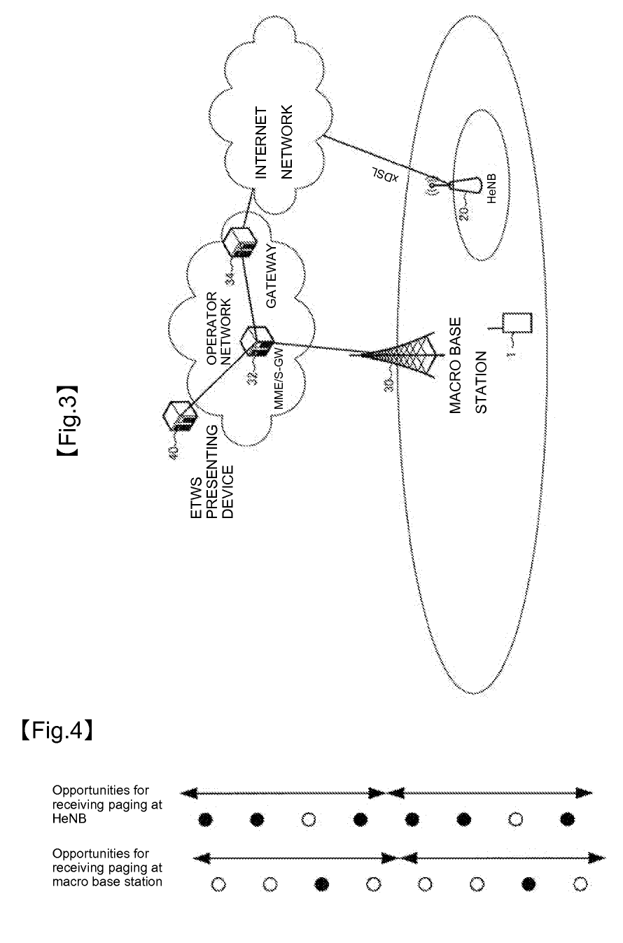

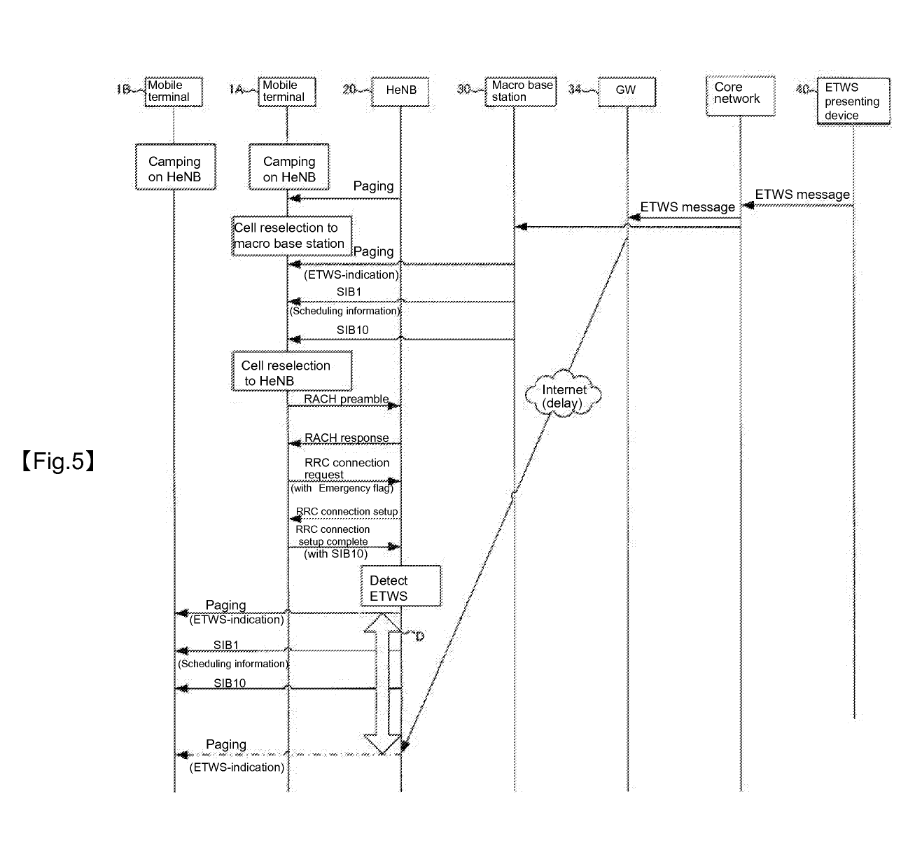

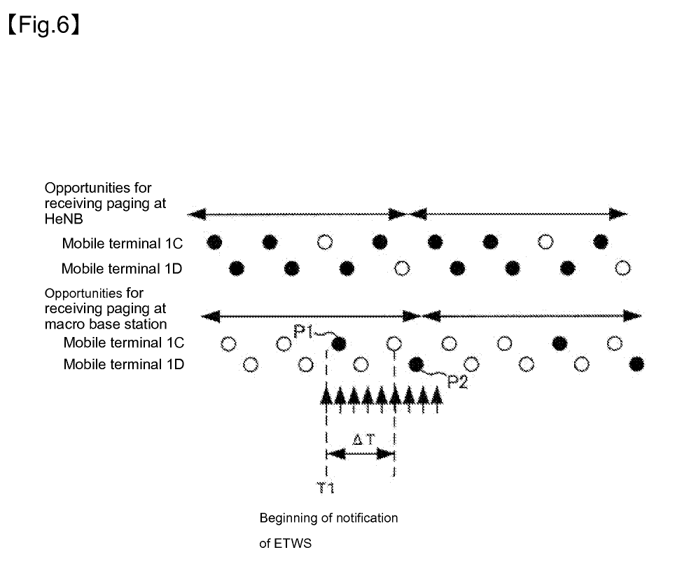

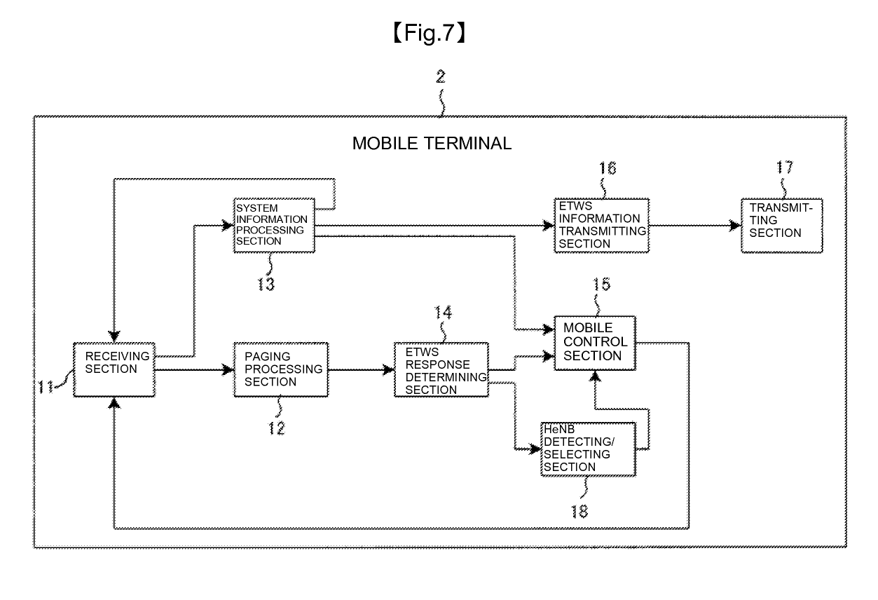

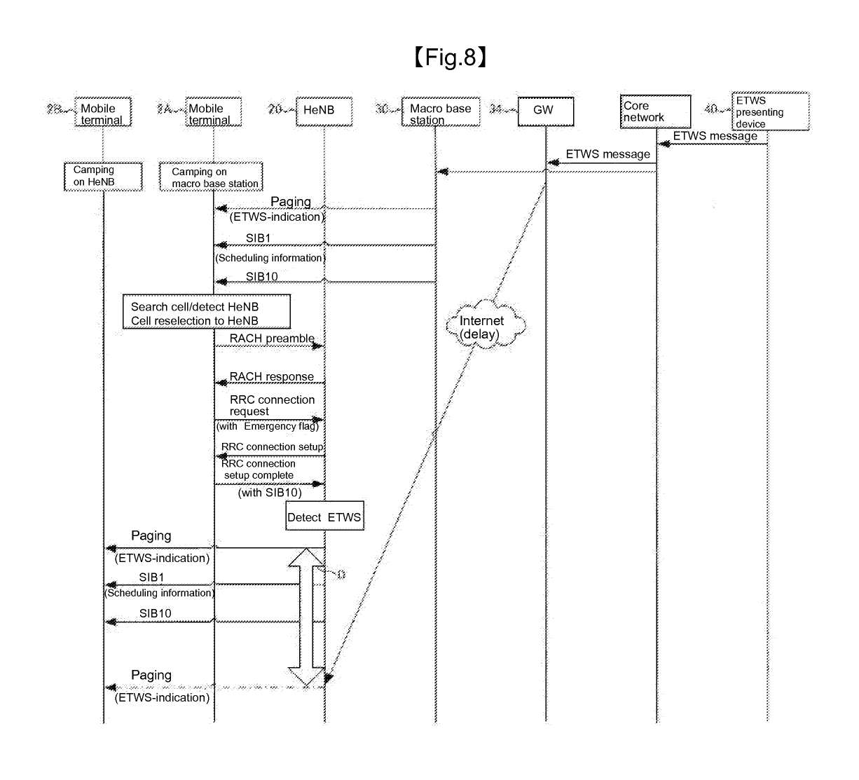

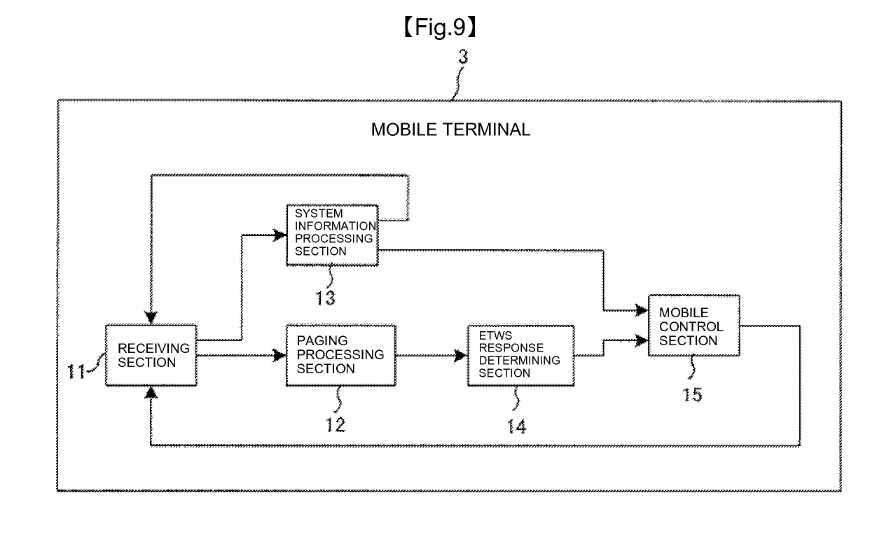

### BRIEF DESCRIPTION OF DRAWINGS

[FIG. 1] FIG. 1 is a diagram showing a configuration of a mobile terminal according to a first embodiment.

[FIG. 2] FIG. 2 is a diagram showing a configuration of an HeNB according to a first embodiment.

[FIG. 3] FIG. 3 is a diagram showing an architecture of an HeNB to which an ETWS is applied.

[FIG. 4] FIG. 4 is a diagram showing timings of receiving paging from an HeNB and a macro base station.

[FIG. 5] FIG. 5 is a diagram for illustrating an operation of the ETWS according to the first embodiment.

[FIG. 6] FIG. 6 is a diagram showing timings of receiving paging from an HeNB and a macro base station.

[FIG. 7] FIG. 7 is a diagram showing a configuration of a mobile terminal according to a second embodiment.

[FIG. 8] FIG. 8 is a diagram for illustrating an operation of the ETWS according to the second embodiment.

[FIG. 9] FIG. 9 is a diagram showing a configuration of a mobile terminal used in a third embodiment.

[FIG. 10] FIG. 10 is a diagram for illustrating an operation of the ETWS according to the third embodiment.

[FIG. 11A] FIG. 11A is a diagram illustrating paging.

[FIG. 11B] FIG. 11B is a diagram showing a configuration of SIB 10.

[FIG. 11C] FIG. 11C is a diagram showing a configuration of SIB 11.

### DESCRIPTION OF EMBODIMENTS

An ETWS according to embodiments of the present invention will now be described below with reference to drawings. The embodiments described below are only illustrative and various modifications can be made to the present invention. Particular configurations and functions disclosed below are not intended to limit the scope of the invention. In the description below, an HeNB is described as an example of a home base station.

### First Embodiment

FIG. 1 is a diagram showing a configuration of a mobile terminal 1 used in an ETWS according to a first embodiment, and FIG. 2 is a diagram showing a configuration of an HeNB 20. In the ETWS according to the embodiment, an ETWS message is notified to the mobile terminal 1 camping on the HeNB 20 without a load of transmitting the ETWS message to a number of HeNBs 20 each in connection with a HeNB gateway independently and without delay. In advance of describing the mobile terminal 1 and the HeNB 20 with reference to FIGS. 1 and 2, description will be made to an architecture of the HeNB 20.

FIG. 3 is a diagram showing an architecture of the HeNB 20 to which the ETWS is applied. A macro base station 30 is connected to an operator network through a Mobility Management Entity (MME)/Serving Gateway (S-GW) 32. The MME is responsible for mobile control, call control, and the like and the S-GW handles data. The operator network is an operator's line that provides a cellular phone service. The MME/S-GW 32 is connected to a gateway 34 that connects the operator network with the Internet network. The HeNB 20 has a connection through the Internet network from the gateway 34 owned by an operator. The ETWS includes an ETWS presenting device 40 connected to a core network provided by the operator. The ETWS presenting device 40 provides an ETWS message.

Next, description will be made to the configuration of the mobile terminal 1 according to the first embodiment with reference to FIG. 1. The mobile terminal 1 includes a receiving section 11 for receiving paging or system information transmitted form the macro base station 30 or the HeNB 20 (hereinafter referred to simply as “base station” collectively if necessary). The receiving section 11 has functions of a “paging receiving section” and an “ETWS receiving section” of the invention. The receiving section 11 passes received paging to a paging processing section 12 and received system information to a system information processing section 13.

The paging processing section 12 processes paging transmitted from a base station. If an ETWS start flag in the paging is on, the paging processing section 12 notifies an ETWS response determining section 14 of the ETWS start flag being on.

The ETWS response determining section 14 corresponds to a “control section” of the invention. The ETWS response determining section 14 controls a mobile control section 15 so that the receiving section 11 receives paging from the macro base station 30 even when the mobile terminal 1 is camping on the HeNB 20. Specifically, the ETWS response determining section 14 controls the mobile control section 15 so that paging from the macro base station 30 is received at a specific timing of receiving paging. The mobile control section 15 performs cell reselection between the HeNB 20 and the macro base station 30 based on an instruction from the ETWS response determining section 14. Cell reselection to the macro base station 30 causes the receiving section 11 to receive paging from the macro base station 30 and cell reselection to the HeNB 20 causes the receiving section 11 to receive paging from the HeNB 20.

FIG. 4 is a diagram showing timings of receiving paging from the HeNB 20 and the macro base station 30. In FIG. 4, circles ◯ (white circle) and (black circle) denote timings at which paging can be received and the circle (black circle) denotes a reception timing. In FIG. 4, double-headed arrows indicate a required period (for example, 4 seconds) required for receiving Primary Notification of an ETWS message. There is a requirement that time required for receiving the Primary Notification by the mobile terminal 1 should be kept within the time period indicated by the double-headed arrows. In FIG. 4, the double-headed arrows are shown based on a System Frame Number (SFN) indicative of a reference timing for the HeNB 20 and the macro base station 30. Since the HeNB 20 and the macro base station 30 may not be synchronized with each other, the double-headed arrows are drawn to show different timings as shown in the figure. Points at which the mobile terminal 1 receives paging are determined based on an International Mobile Subscriber Identity (IMSI) that is a telephone number equivalent of the mobile terminal 1, the SFN, a paging receiving interval, and the number of subframes per radio frame in which the paging is transmitted, as described in the Section 7 of Non Patent Literature 1. Here, the circles denote points at which the mobile terminal 1 receives paging for each of the HeNB 20 and the macro base station 30.

AS shown in FIG. 4, the mobile terminal 1 receives paging from the HeNB 20 in three of four opportunities available for receiving paging during a required period indicated by a double-headed arrow, and receives paging from the macro base station 30 in one opportunity. The number of times of reception of paging is the same as the case where the mobile terminal 1 receives paging from the HeNB 20 in all four opportunities. Therefore, a total signaling cost for reception processing by the mobile terminal 1, and therefore battery consumption of the mobile terminal 1, is hardly different than the case where paging is received only from the HeNB 20. The reception timing shown in FIG. 4 is only an example. It is only necessary for the mobile terminal 1 to receive paging from the macro base station 30 at least once within the required period, and the mobile terminal 1 may receive paging from the macro base station 30 at other timings than those shown in FIG. 4.

The system information processing section 13 performs reception processing of system information received from a base station. The system information processing section 13 acquires scheduling information and the like for each of SIBs included in SIB 1, and controls the receiving section 11 to perform reception processing for other SIBs. The system information processing section 13 can be informed of timings at which SIB 10 and SIB 11 are transmitted by acquiring SIB 1. Since it is predetermined that SIB 1 is sent in a subframe 5 in an even frame of SFN, the mobile terminal 1 can receive SIB 1 at the timing. The system information processing section 13 passes system information required for mobile control on the mobile terminal 1 to the mobile control section 15. The system information processing section 13 passes system information related to ETWS to an ETWS information transmitting section 16.

The ETWS information transmitting section 16 creates and transmits a message for notifying an HeNB of an ETWS message received from the macro base station. The message used here is an RRC Connection Setup Complete message. The ETWS information transmitting section 16 embeds an ETWS message received from the macro base station into the RRC Connection Setup Complete message. The ETWS information transmitting section 16 passes the created message to a transmitting section 17. The transmitting section 17 transmits the message received from the ETWS information transmitting section 16 to the HeNB 20.

Next, the configuration of the HeNB 20 will be described with reference to FIG. 1. The HeNB 20 includes a receiving section 21 for receiving a signal from the mobile terminal 1. The receiving section 21 passes the received message to an ETWS detecting section 22.

The ETWS detecting section 22 detects the presence or absence of an ETWS message from the signal received from the mobile terminal 1. When an RRC Connection Request message is received, the ETWS detecting section 22 detects that an ETWS message will be transmitted in a subsequent RRC Connection Setup Complete message according to a flag indicative of ETWS message notification included in the RRC Connection Request message as an establishment cause. When the RRC Connection Request message does not include, as an establishment cause, any information (for example, emergency access) indicative of whether or not there is an ETWS message, the ETWS detecting section 22 detects the presence of an ETWS message when the HeNB 20 receives an RRC Connection Setup Complete message notifying contents of the ETWS message. The ETWS detecting section 22 notifies that an ETWS message is detected to the ETWS response determining section 23 when ETWS message notification is detected.

The ETWS response determining section 23 determines how the ETWS message should be processed. The ETWS response determining section 23 is operated when ETWS message occurrence is notified through the mobile terminal 1 from the ETWS detecting section 22. Specifically, the ETWS response determining section 23 causes a paging creating section 24 to create paging for notifying the ETWS message being started. The paging created here is a message with an ETWS start flag turned on, which is the same paging as that transmitted from the macro base station 30.

The ETWS response determining section 23 instructs a system information creating section 25 to create SIB 10 and SIB 11. SIB 10 and SIB 11 created here are the same SIB 10 and SIB 11 transmitted from the macro base station 30. The ETWS response determining section 23 causes the creation of system information that has intact or partly altered contents received from the mobile terminal 1.

FIG. 5 is a flow chart for illustrating an operation of ETWS. In FIG. 5, both of a mobile terminal 1A and a mobile terminal 1B are camping on the HeNB 20. The mobile terminal 1A is in an idle state. In FIG. 5, the mobile terminals 1A and 1B are distinguished only for convenience and have the same configuration as the mobile terminal 1.

The mobile terminal 1A on standby at the HeNB 20 receives paging transmitted from the HeNB 20. In the embodiment, the mobile terminal 1A in an idle state receives paging from the macro base station 30 in a specific pattern as shown in FIG. 4. Specifically, the mobile terminal 1A performs cell reselection to the macro base station 30 after it has received paging from the HeNB 20 to receive paging transmitted from the macro base station 30.

As shown in FIG. 5, when an ETWS start flag in paging transmitted from the macro base station 30 is on, the mobile terminal 1A proceeds with reception processing of an ETWS message, instead of immediate cell reselection to the HeNB 20. The mobile terminal 1A receives SIB 1 to acquire scheduling information, and thereafter receives SIB 10, as shown in FIG. 5. When the mobile terminal 1A fails to receive paging, or when the ETWS start flag is off even though paging is received, the mobile terminal 1A performs cell reselection to the HeNB 20. Upon receiving paging, when the mobile terminal 1A determines that there is paging destined to the mobile terminal 1A itself, the mobile terminal 1A performs a normal connect procedure after it returns to the HeNB 20.

Upon receiving an ETWS message of SIB 10 from the macro base station 30, the mobile terminal 1A performs cell reselection to the HeNB 20. The mobile terminal 1A that has received the ETWS message from the macro base station 30 initiates connection processing, i.e. an RRC connection establishment procedure at the HeNB 20. The exact procedure is substantially the same as a normal RRC connection establishment procedure.

The mobile terminal 1A transmits an RACH preamble (Random Access Preamble) in an RACH slot of the HeNB 20. The mobile terminal 1A thereafter receives an RACH response (Random Access Response) from the HeNB 20 and acquires uplink resources to transmit an RRC Connection Request message. The mobile terminal 1A transmits the RRC Connection Request message to the HeNB 20.

The RRC Connection Request message has an establishment cause field that indicates the reason why connection processing is performed. In current specifications, some types of causes are defined, such as an emergency access, a high priority access, an MT access caused by an incoming call, MO signaling indicative of an access for control signaling for procedures such as Tracking Area Update and Attach, and MO data indicative of an access caused by a call for data transmission. Since an access required to carry an ETWS message is for emergencies, the emergency access cause may be used or an additional establishment cause may be defined.

Upon receiving an RRC Connection Request message, the HeNB 20 transmits an RRC Connection Setup message as a response. The HeNB 20 thereby causes the mobile terminal 1A to set up an RRC connection. The mobile terminal 1A reflects the RRC connection setup and transmits an RRC Connection Setup Complete message as a response. At this time, the mobile terminal 1A transmits Primary Notification, i.e. SIB 10, received from the macro base station 30.

The HeNB 20 processes the Primary Notification transmitted from the mobile terminal 1A. The HeNB 20 performs transmission processing of the ETWS message for another mobile terminal 1B connected to the HeNB 20. The procedure is the same as a normal procedure for providing an ETWS message. In other words, the HeNB 20 transmits paging with an ETWS start flag on, transmits SIB 1 notifying scheduling information, and transmits SIB 10 notifying Primary Notification. Although an example of receiving SIB 10 is shown in FIG. 5, SIB 11 can be received in a similar operation. Description has been made above to the configuration and operation of the ETWS according to the first embodiment.

In the ETWS according to the embodiment, even in an idle state, the mobile terminal 1 camping on the HeNB 20 receives paging from the macro base station 30 and receives an ETWS message. The mobile terminal 1 transmits the received ETWS message to the HeNB 20. In this way, the ETWS presenting device 40 can avoid a process of transmitting ETWS messages to a number of HeNBs 20 each in connection with a HeNB gateway independently, and a load of processing ETWS messages can be reduced.

In the ETWS according to the embodiment, since an ETWS message is transmitted without an intervening Internet line, delay of the ETWS message can be suppressed. Through the Internet line, the ETWS message may be delayed before arriving at the HeNB 20 depending, for example, on a congestion condition, and the delay may have a length indicated by a block arrow shown in FIG. 5. According to the embodiment, the delay may be suppressed by using a network whose quality is controlled by an operator. The delay caused by a crowd of individual connections may be suppressed to notify ETWS information.

While the mobile terminal 1 is in an idle state, cell reselection imposes no signaling cost. Therefore, using the mobile terminal 1 in an idle state to relay an ETWS message will not cause an increase of a signaling cost.

Next, a variation of the ETWS according to the first embodiment will now be described. There is a requirement that the maximum allowable delay for Primary Notification should be 4 seconds. In ETWS according to the variation, if paging with an ETWS start flag on is received too late to satisfy the 4-second requirement, the mobile terminal 1 does not transmit any ETWS message to the HeNB 20.

Specifically, time stamp information is included in SIB 10 that notifies Primary Notification. The mobile terminal 1 examines the time stamp to determine whether or not the ETWS message should be transferred to the HeNB 20. Data indicative of which System Frame Number (SFN) is first for transmitting the ETWS message is used as a time stamp. The mobile terminal 1 compares SFN included in SIB 10 with the current SFN to determine whether or not the ETWS message should be transferred to the HeNB 20. In this determination, a value determined by a specification, such as 3s, may be used as a criterion, or a criterion may be transmitted in system information, an individual signal, or the like.

FIG. 6 is a diagram showing timings of receiving paging from the HeNB 20 and the macro base station 30. In FIG. 6, circles ◯ (white circle) and (black circle) denote timings at which mobile terminals 1C and 1D can receive paging and receive the paging at the timing indicated by the circle (black circle). In FIG. 6, although the mobile terminals 1C and 1D are distinguished for convenience, both the mobile terminals 1C and 1D have the same configuration as the mobile terminal 1.

In FIG. 6, notification of an ETWS message is started at time T1. The mobile terminal 1C receives paging P1 from the macro base station 30 and the mobile terminal 1D receives paging P2. A predetermined time ΔT (in second) has not expired since the beginning of notification of the ETWS message at the time when the mobile terminal 1C receives the paging P1, and therefore the mobile terminal 1C transfers the received ETWS message to the HeNB 20. On the other hand, the predetermined time ΔT (in second) has already expired since the beginning of notification of the ETWS message at the time when the mobile terminal 1D receives the paging P2, and therefore the mobile terminal 1D does not transfer the received ETWS message to the HeNB 20.

With processing as described above, in the ETWS according to the variation, any ETWS message that cannot satisfy the requirement is not transferred to the HeNB 20.

In the above case, the mobile terminal 1D that has failed to transfer SIB 10 received from the macro base station 30 to the HeNB 20 may still transfer SIB 11 to the HeNB 20 when the mobile terminal 1D receives the SIB 11.

The time ΔT (in second) that determines whether or not the ETWS message should be transferred to the HeNB 20 may be distributed in any possible ways such as transmitting in system information from the HeNB 20, transmitting in system information from the macro base station, transmitting independently, and using a statically predefined value in specifications.

### Second Embodiment

Next, an ETWS according to a second embodiment will now be described. The architecture of an HeNB 20 according the second embodiment is the same as that of the first embodiment (see FIG. 3).

In this embodiment, once a mobile terminal 2 that is not camping on the HeNB 20 receives an ETWS message, the mobile terminal 2 searches for a neighboring HeNB 20, and when one is detected, transmits the ETWS message to the detected HeNB 20.

FIG. 7 is a diagram showing a configuration of the mobile terminal 2 according to the second embodiment. In addition to the configuration of the mobile terminal 1 according to the first embodiment, the ETWS response determining section 14 is also connected to an HeNB detecting/selecting section 18 in the mobile terminal 2 according to the second embodiment. The HeNB detecting/selecting section 18 functions to search for and select a neighboring cell, and the function is the same as that of an HeNB detecting/selecting section in a conventional mobile terminal. Although not specifically shown in FIG. 1, the mobile terminal 1 according to the first embodiment also has an HeNB detecting/selecting section.

In this embodiment, the HeNB detecting/selecting section 18 is different from a conventional one in that it also has a function of searching for and selecting an HeNB 20 once notified from the ETWS response determining section 14 of an ETWS message being received. The HeNB detecting/selecting section 18 instructs the mobile control section 15 to perform mobile control to a detected HeNB 20.

The configuration of the HeNB 20 according the second embodiment is the same as that of the first embodiment.

FIG. 8 is a flow chart for illustrating an operation of the ETWS according to the second embodiment. In FIG. 8, a mobile terminal 2A is camping on the macro base station 30 and a mobile terminal 2B is camping on the HeNB 20. In FIG. 8, although the mobile terminals 2A and 2B are distinguished for convenience, both the mobile terminals 2A and 2B have the same configuration as the mobile terminal 2.

The mobile terminal 2A receives paging from the macro base station 30 since it is camping on the macro base station 30. When an ETWS start flag in paging received from the macro base station 30 is on, the mobile terminal 2A performs reception processing of an ETWS message.

Upon receiving SIB 10 notifying Primary Notification, the mobile terminal 2A starts to search for a neighboring HeNB 20. When such an HeNB 20 is detected, the mobile terminal 2A accesses the detected HeNB 20. The HeNB 20 and the macro base station 30 use cell identifiers different from each other at a L1 level. Specifically, among 512 identifiers, identifiers used by the HeNB 20 and those used by the macro base station 30 are separated from each other in advance and the classification is notified to the mobile terminal 2. This allows the mobile terminal 2 to detect whether or not the searched base station is the HeNB 20.

There are two types of HeNB 20: an acceptable cell accessible to the mobile terminal 2 and a suitable cell that is accessible to and provides services for the mobile terminal 2. In normal situation, the mobile terminal 2 can camp on a serving cell and cannot camp on a cell that is accessible only. The HeNB 20 receives service type information from the mobile terminal 2 when the HeNB 20 performs a connection processing procedure. The HeNB 20 determines whether or not it can provide the service based on a service type, and rejects connection from a mobile terminal 2 that cannot be serviced.

In this embodiment, a service type “emergency” or “ETWS” is notified to the HeNB 20. In this way, the mobile terminal 2 can notify an ETWS message to an HeNB 20 of a cell on which the mobile terminal 2 would not normally be allowed to camp.

In this embodiment, the mobile terminal 2 notifies an ETWS message to the HeNB 20 on which the mobile terminal 2 would not normally be allowed to camp. In this way, even when the HeNB 20 cannot receive an ETWS message from a subordinate mobile terminal 2, the HeNB 20 can receive an ETWS message from other mobile terminals 2. Therefore, likelihood that the HeNB 20 can receive an ETWS message through the mobile terminal 2 increases.

In the ETWS according to the embodiment, similarly to the first embodiment, the ETWS presenting device 40 can avoid a process of transmitting ETWS messages to a number of HeNBs 20 each in connection with a HeNB gateway independently. Therefore, a load of processing ETWS messages can be reduced, and the delay caused by a crowd of individual connections may be suppressed to notify ETWS information.

In the second embodiment, similarly to the variation of the first embodiment, the mobile terminal 2 may or may not transfer an ETWS message to the HeNB 20 depending on a timing of receiving paging with an ETWS start flag on.

### Third Embodiment

Next, an ETWS according to a third embodiment will now be described. The architecture of an HeNB 20 according the third embodiment is the same as that of the first embodiment (see FIG. 3).

FIG. 9 is a diagram showing a configuration of a mobile terminal 3 used in the third embodiment. The mobile terminal 3 according to the third embodiment includes a receiving section 11 for receiving paging and system information transmitted from the base station, a paging processing section 12 for processing the paging, and a system information processing section 13 for processing the system information. The receiving section 11 passes received paging to a paging processing section 12 and received system information to a system information processing section 13.

If the ETWS start flag is on in the paging, the paging processing section 12 notifies it to the ETWS response determining section 14. The system information processing section 13 acquires scheduling information and the like for each of SIBs included in SIB 1, and causes the receiving section 11 to perform reception processing for other SIBs. The system information processing section 13 passes system information required for mobile control to the mobile control section 15.

When ETWS message occurrence is notified from the paging processing section 12, the ETWS response determining section 14 determines which processing should be performed. When the mobile terminal 3 is connected to the HeNB 20, the ETWS response determining section 14 determines that it performs cell reselection to the macro base station 30 and notifies it to the mobile control section 15.

The mobile control section 15 performs mobile control on the mobile terminal 3, and performs cell reselection to a neighboring macro base station 30 according to notification from the ETWS response determining section 14.

FIG. 10 is a flow chart for illustrating an operation of the ETWS according to the third embodiment. The mobile terminal 3 is camping on the HeNB 20 and receives paging from the HeNB 20. In this embodiment, the mobile terminal 3 camping on the HeNB 20 does not perform reception processing of paging transmitted from the macro base station 30.

If the ETWS start flag is on in the paging, the mobile terminal 3 performs cell reselection to the macro base station 30. The mobile terminal 3 receives SIB 1 transmitted from the macro base station 30 to acquire transmission scheduling information for other SIBs, and receives SIB 10 notifying Primary Notification from the macro base station 30 according to the scheduling information.

The mobile terminal 3 continues to camp on the macro base station 30 and receives paging from the macro base station 30. If the ETWS start flag is on in the received paging, the mobile terminal 3 receives SIB 1 transmitted from the macro base station 30 to acquire transmission scheduling information for other SIBs, and receives SIB 11 notifying Secondary Notification according to the scheduling information. Description has been made above to the ETWS according to the third embodiment.

In the third embodiment, the HeNB 20 transmits only paging that includes an ETWS start flag. Upon receiving paging with an ETWS start flag on, the mobile terminal 3 performs cell reselection to a neighboring macro base station 30 to receive an ETWS message from the macro base station 30. An excess load on the Internet network or xDSL can thereby be suppressed only to the ETWS start flag. The amount of information of the ETWS start flag is one bit, which places much less burden even when the information is transmitted to all HeNBs 20.

Description has been made above to the ETWS and mobile terminal according to the invention in detail with reference to embodiments; the present invention, however, is not limited to the embodiments.

In the first embodiment described above, the mobile terminal 1 camping on the HeNB 20 in an idle state receives paging from the macro base station 30 once in four opportunities, as shown in FIG. 4. How often the mobile terminal 1 receives paging from the macro base station 30 may be uniquely predefined in specifications, may be notified in system information, or may be notified independently. As an example of notifying in system information, it is conceivable to define the number of opportunities in which the mobile terminal 1 receives paging from the macro base station 30 once. Specifically, if it is once in four opportunities, the number “4” is notified. However, other ways of notification may be adopted.

Information used to determine the frequency and timing of receiving paging from the macro base station 30 may be distributed in any possible ways such as transmitting in system information from the HeNB, transmitting in system information from the macro base station, transmitting independently, and using a statically predefined value in specifications.

Similarly, a number of ways of determining reception timings are conceivable. As an example, the determination may be made based on an identification of the mobile terminal 1. For example, in the case where the mobile terminal 1 receives paging from the macro base station 30 once in four opportunities as described above, the number determined by an identification (IMSI or S-TMSI) of the mobile terminal 1 mod 4. Here, in the case where system information is individually transmitted to a mobile terminal, the value of 4 is transmitted to the mobile terminal. In the case of a static value predefined in specifications, a value of 4 is defined in specifications. Given that timings of receiving paging are distributed for two or more mobile terminals in connection with the HeNB 20, independent signaling may be used to designate a specific opportunity.

In the first embodiment described above, in cases where SIB 10 and SIB 11 are provided at the same time, the mobile terminal 1 needs to determine when it should return to the HeNB 20: at the time when SIB 10 is received or at the time when SIB 11 is received. Currently, since a strict delay requirement is imposed only on SIB 10, it is conceivable to return to the HeNB 20 at the time when SIB 10 is received. However, it is possible to receive also SIB 11 when, for example, there is less delay even after SIB 11 is received.

In the first embodiment described above, the ETWS response determining section 14 controls the mobile control section 15 so that the receiving section 11 receives paging from the macro base station 30; the ETWS response determining section 14 may instead control the receiving section 11.

In the first and second embodiments described above, it is assumed that both SIB 10 and SIB 11 are transferred from the mobile terminal 1 or 2 to the HeNB 20; the operation may instead be applied only to SIB 10. In this case, the mobile terminal 1 or 2 that has received SIB 10 from the HeNB 20 operates to perform mobile control to the macro base station 30, for example.

In the first and second embodiments described above, the operation that the mobile terminal 1 or 2 transmits received SIB 10 or SIB 11 to the HeNB 20 has been illustrated. It is, however, possible for the mobile terminal 1 or 2 to notify the HeNB 20 only of transmission of an ETWS message being started, instead of transferring SIB 10 or SIB 11. In this case, the mobile terminal 1 or 2 that has received paging with an ETWS start flag on from the HeNB 20 starts reception processing of a signal from the macro base station 30.

In the first and second embodiments described above, the HeNB 20 may check whether an ETWS message transmitted from the mobile terminal 1 or 2 is authentic or not. To do this, warningSecuritylnformation included in SIB 10 may be used. warningSecuritylnformation is used to check whether or not SIB 10 received by the mobile terminal 1 or 2 has been received from the correct base station. Notifying the information to the HeNB 20 by the mobile terminal 1 or 2 allows the HeNB 20 to know indirectly whether ETWS notification from the mobile terminal 1 or 2 is correct or not. A false ETWS message from the mobile terminal 1 or 2 can thereby be found and eliminated.

In the embodiments described above, a procedure to use an RRC Connection Setup Complete message to transmit an ETWS message has been illustrated. However, an RRC Connection Request message may be used to transmit the ETWS message, or any other messages such as, for example, a UL Information Transfer message used to transmit a NAS message may be used to transmit the ETWS message.

Although preferred embodiments of the present invention conceivable at this time have been described, various modifications may be made to the embodiments and the attached claims are intended to encompass all such modifications that fall within the scope and true spirit of the invention.

### INDUSTRIAL APPLICABILITY

As described above, the present invention has advantages that a load of transmitting ETWS information to home base stations can be reduced and delay caused by a crowd of a transmission network may be suppressed, and the present invention is useful for ETWS for notifying ETWS information to mobile terminals camping on an HeNB.

### REFERENCE SIGNS LIST

1-3 Mobile terminal
11 Receiving section
12 Paging processing section
13 System information processing section
14 ETWS response determining section
15 Mobile control section
16 ETWS information transmitting section
17 Transmitting section
18 HeNB detecting/selecting section
20 HeNB
21 Receiving section
22 ETWS detecting section
23 ETWS response determining section
24 Paging creating section
25 System information creating section
26 Transmitting section
30 Macro base station
32 MME/S-GW
34 Gateway
40 ETWS presenting device

1. A mobile terminal for use in a network comprising a macro base station and a home base station, comprising:
a paging receiving section for receiving paging transmitted from the macro base station or the home base station; and
a control section for controlling the paging receiving section to receive paging from the macro base station when the mobile terminal is in connection with the home base station and in an idle state, the paging being received at least once in a duration in which Earthquake and Tsunami Warning System (ETWS) information should be received.

2. The mobile terminal according to claim 1, further comprising:
an ETWS receiving section for receiving ETWS information transmitted from the macro base station when the received paging indicates that the ETWS information is present; and
an ETWS transmitting section for transmitting the ETWS information to the home base station.

3. The mobile terminal according to claim 2, wherein the ETWS information includes information indicative of start time of transmission of the ETWS information, and
the ETWS transmitting section transmits the ETWS information to the home base station when the ETWS information is received before a predetermined threshold time has expired since the start time of transmission.

4. A mobile terminal for use in a network comprising a macro base station and a home base station, comprising:
a paging receiving section for receiving paging transmitted from the macro base station;
an ETWS receiving section for receiving ETWS information transmitted from the macro base station when the paging includes a start signal of the ETWS information;
a detecting section for detecting a home base station when the ETWS information is received; and
an ETWS transmitting section for, when the detecting section detects a home base station, transmitting the ETWS information to the detected home base station.

5. The mobile terminal according to claim 4, wherein the ETWS information includes information indicative of start time of transmission of the ETWS information, and
the detecting section detects a home base station when the ETWS information is received before a predetermined threshold time has expired since the start time of transmission.

6. A mobile terminal for use in a network comprising a macro base station and a home base station, comprising:
a paging receiving section for receiving paging transmitted from the home base station; and
a mobile control section for connecting the mobile terminal to the macro base station so as to receive ETWS information when the paging received from the home base station indicates that the ETWS information is present.

7. A home base station, comprising:
an ETWS receiving section for receiving ETWS information transmitted from a mobile terminal in response to the ETWS information being received from a macro base station; and
an ETWS transmitting section for, when the receiving section receives the ETWS information, transmitting system information that includes the ETWS information received from the mobile terminal.

8. An Earthquake and Tsunami Warning System, comprising:
a macro base station;
a home base station; and
a mobile terminal,
wherein the mobile terminal comprises:
a paging receiving section for receiving paging transmitted from the macro base station or the home base station;
a control section for controlling the paging receiving section to receive paging from the macro base station even when the mobile terminal is in connection with the home base station and in an idle state;
an ETWS receiving section for receiving ETWS information transmitted from the macro base station when the received paging indicates that the ETWS information is present; and
an ETWS transmitting section for transmitting the ETWS information to the home base station, and
wherein the home base station comprises:
an ETWS receiving section for receiving the ETWS information transmitted from the mobile terminal;
an ETWS transmitting section for, when the ETWS receiving section receives the ETWS information, transmitting system information that includes the ETWS information received from the mobile terminal.

9. A control method for a mobile terminal for use in a network comprising a macro base station and a home base station, the method comprising:
in the mobile terminal,
receiving paging from the macro base station even when the mobile terminal is in connection with the home base station and in an idle state;
receiving ETWS information transmitted from the macro base station when the received paging indicates that the ETWS information is present; and
transmitting the ETWS information to the home base station.

10. A control method for a home base station for use in a network comprising a macro base station and a home base station, the method comprising:
in the home base station,
receiving ETWS information transmitted from a mobile terminal in response to the ETWS information being received from a macro base station; and
when the ETWS information is received, transmitting system information that includes the ETWS information received from the mobile terminal.
